(19) United States
(12) Patent Application Publication
(10) Pub. No.: US 2010/0133447 A1
(43) Pub. Date: Jun. 3, 2010

(54) Acousto-Optical Test and Analysis Cavitation Chamber

(75) Inventors: Dario Felipe Gaitan, Nevada City, CA (US); Robert Hiller, Grass Valley, CA (US)

Correspondence Address: Intrinsic Law Corp., 235 Bear Hill Road, Suite 301, Waltham, MA, 02451, US

(73) Assignee: IMPULSE DEVICES, INC., Grass Valley, CA (US)

(21) Appl. No.: 12/557,420

(22) Filed: Sep. 10, 2009

Related U.S. Application Data
(60) Provisional application No. 61/191,589, filed on Sep. 10, 2008.

(51) Int. Cl. G01N 21/70; B06B 1/06; G01J 1/42

(52) U.S. Cl. 250/432 R; 310/322; 250/227.11

(57) ABSTRACT

An apparatus for cavitation and sonoluminescence is provided. In some embodiments the apparatus provides high-intensity shock waves that modify the properties of the liquid medium in the resonator and thereby alter the optical and electrical properties of the liquid. Methods for studying the acoustical and optical characteristics of the liquid and the sound fields in such scenarios are enabled and thereby testing and analysis of the same are made possible.

### CROSS-REFERENCE TO RELATED APPLICATIONS

The present application is related to and claims the benefit and priority under 35 U.S.C. §119 of U.S. Provisional Application No. 61/191,589 filed on Sep. 10, 2008, which is hereby incorporated by reference.

### GOVERNMENT FUNDING

The invention described herein was made at least in part with U.S. government support under Contract No. W9113M-07-C-0178, which was awarded by the U.S. Space and Missile Defense Command and subcontracted to the assignee. Accordingly, the government may have certain rights in the subject invention

### TECHNICAL FIELD

This application relates to the field of acoustic cavitation and sonoluminescence. In particular, it relates to the coupling of acoustic and optical characteristics of fluids resulting from high-intensity cavitation within a cavitation chamber or resonator, and the resonators and test chambers to cause and study the same.

### BACKGROUND

It is known that cavitation can occur in liquids when a portion of a liquid volume is driven to a state such that the local pressure at that portion drops below the vapor pressure for the liquid under the local conditions. For example, cavitation is observed near the low-pressure or trailing edge of a propeller blade rotating in water such as in marine propulsion systems. Also, cavitation has been generated at nucleation sites in the laboratory where cyclic pressure drops are provided at the nucleation site by application of an acoustic driving signal. The acoustic driving signal generally provides an oscillating pressure in the liquid around a zero-DC reference point so that a portion of the driving cycle places the given location at an elevated pressure above the DC ambient pressure, while another portion of the driving cycle places the given location at a reduced (or negative) pressure below the DC ambient pressure. In these examples, the liquid breaks or tears at the negative pressure location so as to cause a relative vacuum or vapor (gas) cavity at the negative pressure location. This gas cavity is known as a cavitation bubble, and may be a single spherical cavity or may be a non-spherical cavity, or may be a collection of some or many such bubbles clustered about the general negative pressure region of the liquid. A cluster of cavitation bubbles is sometimes referred to as a cavitation bubble cloud, which includes a plurality of cavitation bubbles responsive to a driving or environmental condition in the vicinity of the bubble cloud.

Another phenomenon which has been observed in liquid cavitation systems is sonoluminescence. This phenomenon relates to light emission from collapsing cavitation bubbles under certain conditions. The phenomenon is usually associated with a sufficiently strong collapse of a cavitation bubble such that a resulting shock wave within the collapsing bubble generates temperatures within the bubble to cause emission of light that has been correlated with a black-body radiation within the bubble. The emitted light released by sonoluminescence can be in the visible range, and the spectrum thereof has been studied and the underlying temperatures within collapsing cavitation bubbles has been postulated and computed using various models and has been measured spectroscopically in the laboratory. Sonoluminescence can result from single bubble events, called single-bubble sonoluminescence (SBSL) or from multiple bubble events, called multi-bubble sonoluminescence (MBSL).

### SUMMARY

Various embodiments hereof are directed to acoustical resonators for achieving cavitation and sonoluminescence in liquids within the resonators. More specifically, embodiments hereof provide useful test and analysis apparatus for studying the behavior of liquids experiencing cavitation, including spontaneous cavitation within a pressurized cavitation chamber or resonator. Yet more specifically, aspects hereof provide useful and new systems and methods for creating cavitation and sonoluminescence in acoustical resonators and for measuring the properties of the acoustic fields and optical properties of the liquids within the resonators.

Some embodiments are directed to a system for achieving cavitation within a liquid medium comprising a resonator having a shell body substantially enclosing the liquid medium and defining an inner volume within which the liquid medium is confined; a driving element coupled to said resonator for imparting energy to the resonator for causing cavitation in at least one region of the fluid medium within said resonator; a fluid pressure control apparatus to control a static pressure of the fluid medium within said resonator; and an aperture within said shell body through which electromagnetic radiation may pass. Other embodiments include also a fluid handling loop to the system, as well as a control apparatus to control the acoustical behavior of the system.

Still other embodiments are directed to a method for determining an optical characteristic of a fluid medium comprising placing said fluid medium in a substantially enclosed resonator volume; raising a static pressure of said fluid medium within said resonator to a given static pressure range; applying an acoustical driving energy to said resonator so as to cause a sonoluminescence event in at least one region of said fluid medium within said resonator and so as to emit light from said region as a result of said sonoluminescence event; and determining a phase of said fluid medium where said phase deminishes a transmission characteristic of at least a range of wavelengths of said light emitted from said sonoluminescence event. Yet other embodiments comprise determining a phase of the fluid to measure the opacity of the fluid. Tests and analysis of the acoustic and optical conditions within the resonator can then be carried out.

### BRIEF DESCRIPTION OF THE DRAWINGS

The present discussion can be better understood when reviewed in connection with the associated drawings, in which:

FIG. 1 illustrates an exemplary cavitation and sonoluminescence resonator;

FIG. 2 illustrates a portion of the shell of a resonator having an optical penetration or aperture therethrough;

FIG. 3 illustrates an exemplary measurement of the photon emission or light intensity of sonoluminescence events within a resonator;

FIG. 4 illustrates exemplary photon counts and energy from sonoluminescence events;

FIG. 5 illustrates an exemplary system for causing cavitation in a resonator and for detecting the sonoluminescence light emissions therefrom;

FIG. 6 illustrates an exemplary light emission versus time plot for an exemplary resonator;

FIG. 7 illustrates a more detailed light emission versus time plot;

FIG. 8 illustrates the absorption coefficient of water as a function of frequency according to the prior art;

FIG. 9 illustrates color temperature and radius as a function of time for an exemplary SBSL event;

FIG. 10 illustrates the pressure and zone coordinate for cavitation in an exemplary resonator;

FIG. 11 illustrates the pressure and zone coordinate for cavitation in an exemplary resonator; and

FIG. 12 illustrates phase transitions in liquid (e.g., water).

### DETAILED DESCRIPTION

Several useful applications of sonoluminescence and cavitation technology have been devised and proposed. These include for example material processing for industrial, medical, and other scientific uses. Also, for transformation of solid and liquid materials to obtain useful by-products thereof. In addition, applications in energy conversion and generation are also possible. Better understanding of the qualitative and quantitative aspects of cavitation and sonoluminescence are of interest as well. In addition, test and analysis systems for studying the effects of acoustic and physical parameter space on liquids and other materials are needed. The present description provides a number of embodiments for such test and analysis systems, as well as methods for using the same.

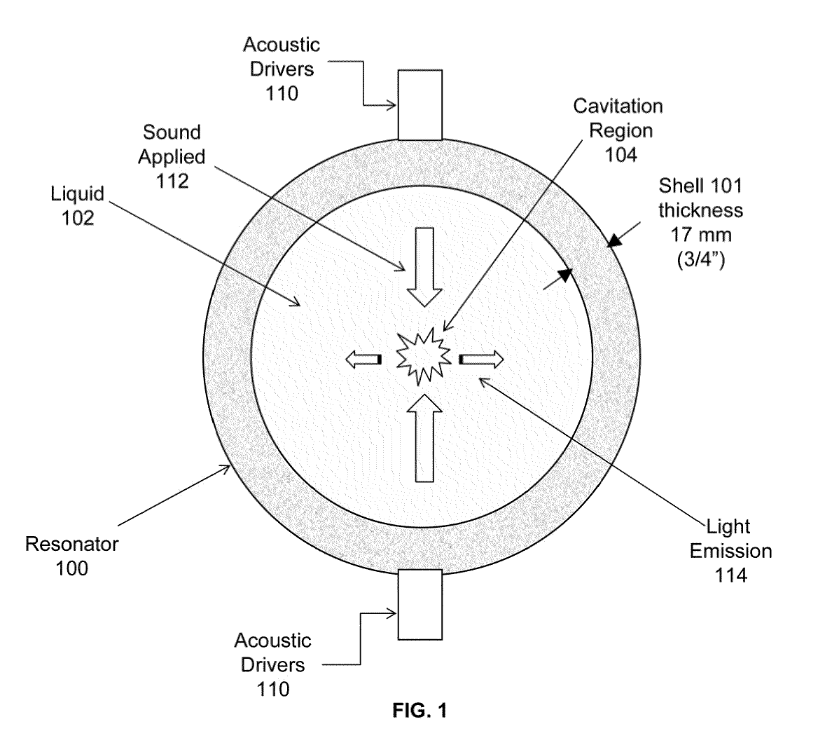

FIG. 1 illustrates a simplified apparatus for generating cavitation and sometimes sonoluminescence in a cavitation chamber (or acoustic resonator). The resonator 100 is configured to provide sound waves or other pressure waves into a closed volume therein. In the embodiment of FIG. 1, the resonator 100 comprises a solid shell 101, which may for example be made of metal such as stainless steel, aluminum, or other suitable solid material. A volume within the resonator contains a liquid 102 that experiences and propagates the pressure (e.g., ultrasonic) waves from the shell 101 into the volume.

One or more acoustic drivers 110 provide driving energy to cause the walls of the resonator 100 to react thereto, and thereby to transmit such energy, sound, ultrasound, or pressure waves into the volume of the resonator and the liquid 102 therein. In certain configurations of resonator 100, the sound or pressure waves generated by acoustic drivers 110 are propagated to one or more locations within the resonator.

In some embodiments, the resonator 100 has a spherical or substantially-spherical shape. In this case, the symmetry of the resonator 100 will cause a concentration of the applied sound or pressure field at or near the geometric center of the resonator 100. The shell 101 of resonator 100 may be constructed of stainless steel having a thickness of ¾ inches (or 17 mm) and the resonator 100 may have an inner diameter of about 10 to 20 cm.

Under appropriate conditions, cavitation will occur, for example at or near cavitation region 104. In yet more specific conditions, sonoluminescence will occur at or near cavitation region 104. FIG. 1 illustrates this scenario in a simplified way by showing sound applied 112 and light emission 114 resulting from the sonoluminescence.

The resonator 100 can be equipped with myriad auxiliary components. For example, fluid handling loops can be coupled to resonator 100 so that the chamber can be filled and vacated with liquid 102. Also, a pressure control, temperature control, filtration system, and other fluid processing, monitoring, and handling systems can be coupled thereto.

Also, plugs, orifices, and other means of communication between the resonator 100 and fluid 102 and the outside of resonator 100 can be included in the design of the present system. In some embodiments, an optical window is installed in the side of resonator shell 101. For example a generally circular optical window can be made of glass, quartz, or other optically-suitable material can be used so that observations of the internal workings of resonator can be made. Instrumentation may be coupled to resonator 100 so that the light emissions 114 from the cavitation region 104 can be seen or measured.

It should be understood that non-spherical configurations of the resonator can be made. For example, cylindrical-shaped configurations can also be designed and used for the present purpose. Also, a variety of drivers can be employed for generating cavitation and sonoluminescence according to the present description. In some embodiments, acoustic horns or pill drivers can be coupled to resonator shell 101 to cause shell 101 to resonate at a driving frequency. The driving frequency can be an ultrasonic frequency, e.g., a frequency above 20 kHz. In other embodiments, the driving frequency is set to conform to a physical dimension and/or shape of the resonator 100. The resonator 100 can be made to vibrate or oscillate or respond to the driving energy from drivers 110 to produce the desired energy (e.g., acoustic) field within the cavity defined by resonator shell 101.

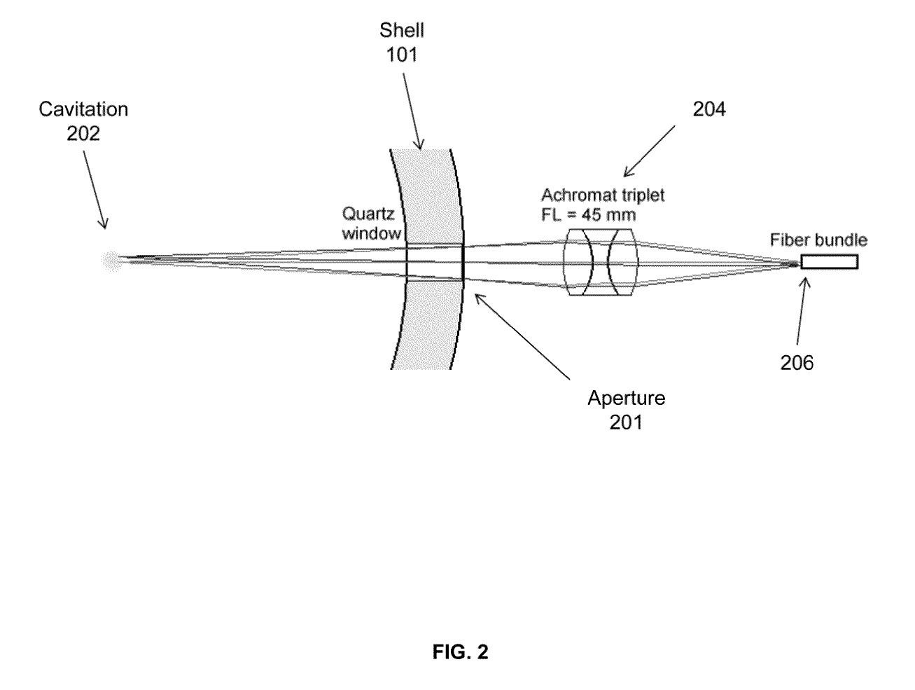

FIG. 2 illustrates a portion of resonator 100 showing an exemplary embodiment of a penetration in shell 101 thereof for passage of light. Resonator shell 101 is provided with an aperture 201. Aperture 201 includes an optically-permissive window, for example a quartz window or other suitable window material that allows passage of a given range of the optical spectrum. In this way, light emitted by a cavitation event 202 can be collected, studied, and measured. For example, spectroscopic analysis may be conducted on the light emitted from cavitation event 202.

The quartz window may be machined to the same dimensions as aperture 201 in some embodiments. For example, the window may be machined to have the same thickness as the shell 101, or to have a different thickness greater or less than the thickness of shell 101. Also, the quartz window may be machined to have a contour or surface shape (e.g., a curvature) to suit or match that of the host portion of shell 101. In a specific embodiment, the quartz window has a spherical inner and outer profile on its inner and outer surfaces respectively.

FIG. 2 also shows an achromat triplet optical lens assembly 204 having a given focal length (e.g., 45 mm) to collect and focus the light emitted from aperture 201. The lens 204 focuses the light it collects onto a desired focal spot, for example onto a fiber optic bundle 206 for processing and/or transmission to another component of the system.

As mentioned earlier, the present apparatus can be configured to operate at a variety of conditions. For example, a static pressure within the resonator 100 can be set by changing and controlling the pressure of the fluid in the system.

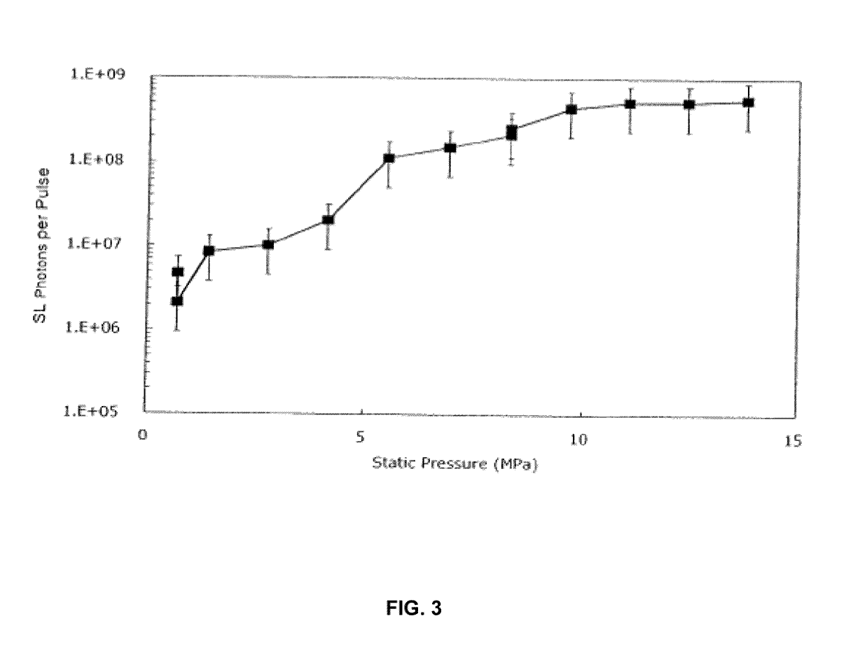

FIG. 3 illustrates an exemplary measurement of the photon emission or light intensity of sonoluminescence events within resonator 100 as a function of the static pressure applied to the fluid in the resonator. The static pressure is substantially a constant or DC component of pressure that determines the ambient pressure conditions in the vicinity of a SBSL or MBSL event in the resonator. The driving acoustic field is applied in addition to this static or background fluid pressure, and generally provides an oscillating periodic (e.g., sinusoidal) increase and decrease in pressure within the resonator. It can be seen in this exemplary embodiment that there is a relationship between the static pressure within resonator 100 and the intensity of the emitted sonoluminescence (SL), as measured by the number of emitted photons.

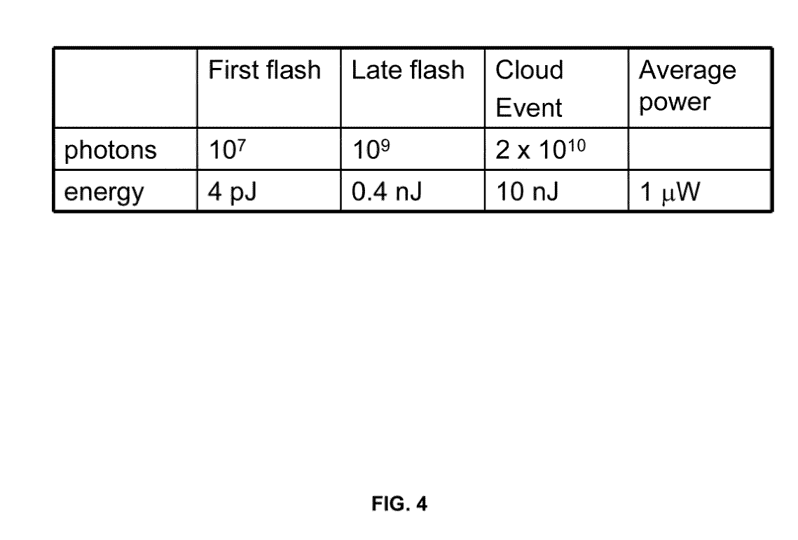

FIG. 4 illustrates the number of photons and energy in an early and a later collapse event of a SL bubble, or flash, and the average power provided therefrom. It should be appreciated that specific conditions, resonator geometries and other factors will affect the results. Therefore, in some embodiments, it can be useful to have a positive-pressure, and even a highly pressurized resonator vessel for conducting sonoluminescence therein. In some embodiments the cavitation and sonoluminescence are caused and a static pressure above 1 Mpa over ambient. In other embodiments the static pressure within the resonator is over 10 Mpa. In yet other embodiments the static pressure in the resonator is over 20 Mpa. In still other embodiments, the static pressure in the resonator is over 30 Mpa. This can entail a strengthened resonator shell and fluid and aperture components that can withstand such a static pressure during operation.

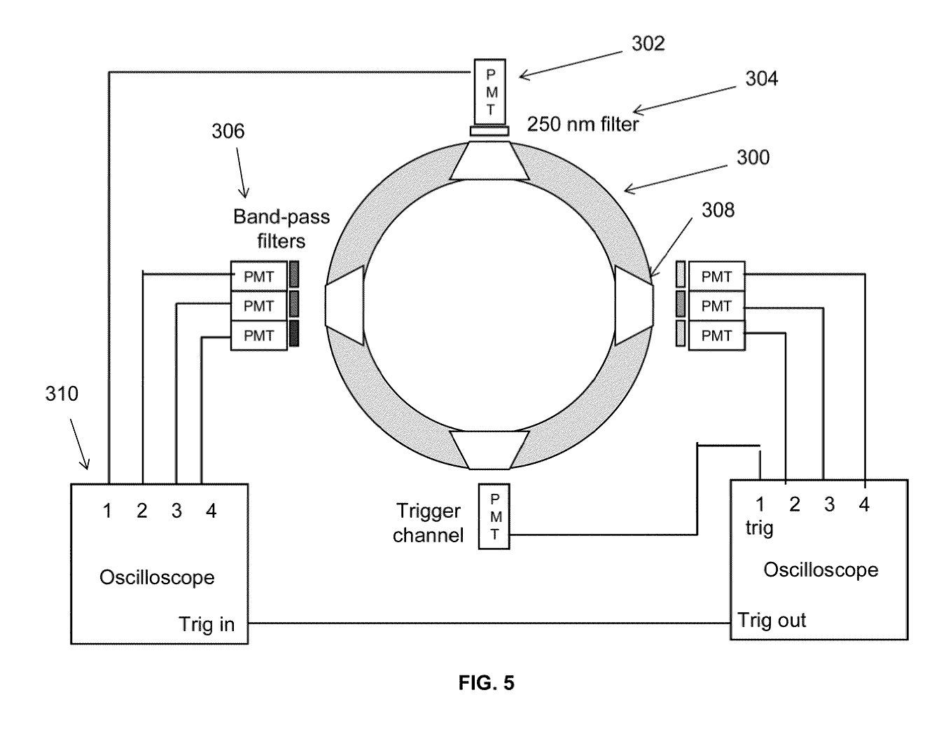

FIG. 5 illustrates an exemplary system for testing and analysis, in the context discussed above. The system includes a resonator 300, which may be constructed along the lines laid out in the above embodiments. The resonator 300 is fluid filled and can be pressurized to some static pressure as discussed earlier. The resonator 300 is further provided with acoustic drivers (not shown) that can cause cavitation and/or sonoluminescence at or near the center of resonator 300.

One or more apertures 308 are provided in the shell of resonator 300. The apertures are equipped with light-transmissive windows for studying the emissions from sonoluminescence events in resonator 300. One or more photomultiplier tubes (PMTs) 302 are set up outside of each aperture 308 to collect the photons coming out of apertures 308. The PMTs collect the incident light arriving at the PMTs and amplify the incident light to yield a useful signal for analysis. In addition, there is an optical filter, e.g., band-pass filter 306 that can control the transmission of light through the filter. Several band-pass filters 306 may be arranged by the respective PMTs to collect wavelength-specific light into the corresponding PMT. For example, a 250 nm filter can be placed in front of PMT 302. One or more oscilloscopes 310 are provided to synchronize the events and the data collection in the system of FIG. 5, using for example one or more triggers.

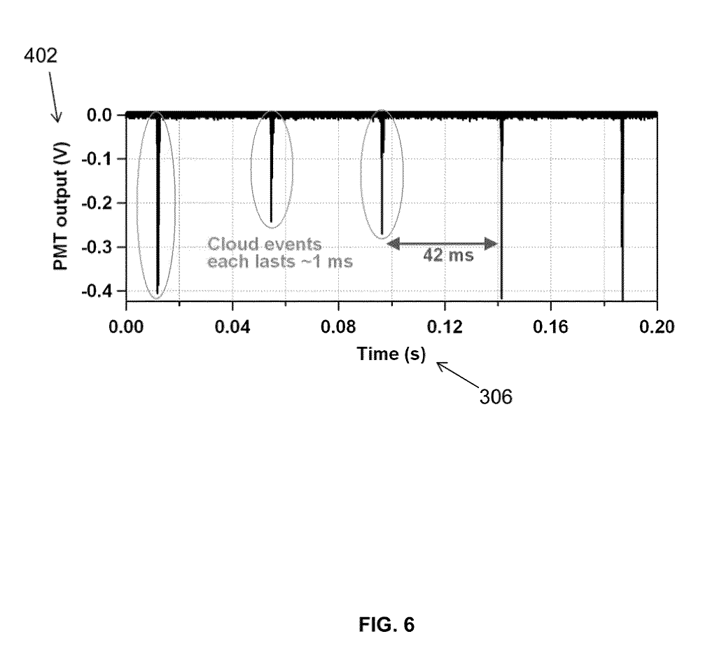

FIG. 6 illustrates an exemplary set of data for a sonoluminescence event. The data shows the PMT output voltage 402 against the time 404 (in seconds). Various events within the resonator result in varying outputs from the PMTs. One such type of cavitation/sonoluminescence event is the formation of a cavitation bubble cloud. The bubble cloud acts as a mass of bubbles collectively, and exhibits optical SL emissions accordingly. The cloud events of FIG. 6 last for example for about 1 millisecond, and occur about 42 milliseconds apart in this illustrative example. The 42 milliseconds represents the approximate acoustic period of the driving sound field of the apparatus.

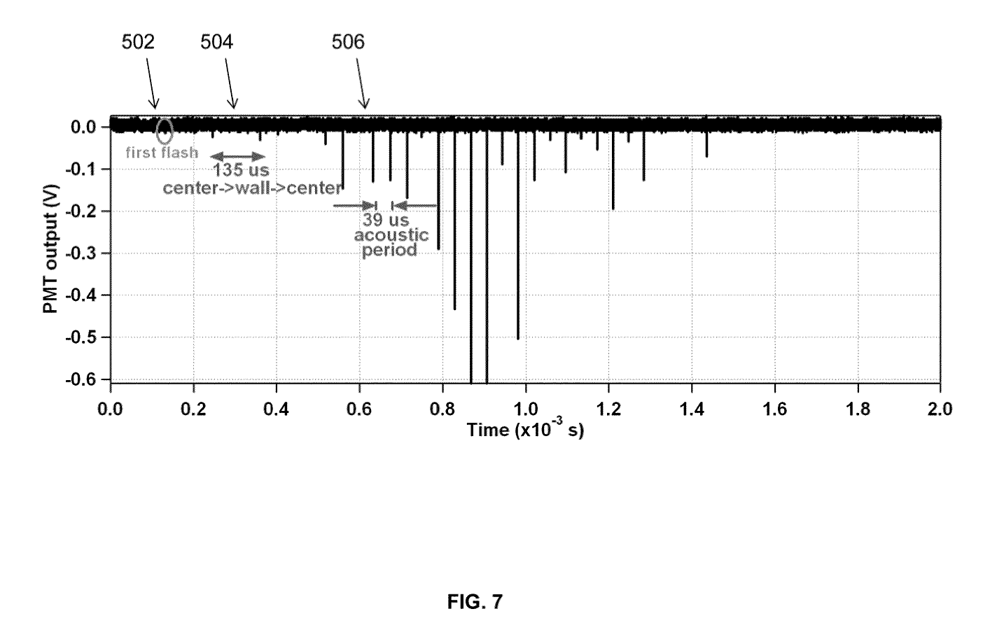

FIG. 7 illustrates the optical flashes of light observed using the PMTs of the present apparatus as a function of time. What can be seen is that the sonoluminescence events, e.g., from MBSL cloud collapses, emits light which is indicative of a number of features of the events. Here one can see the initial “first” flash of light 502 of some intensity. Following the first flash of light 502 the PMTs pick up subsequent light emissions indicative of a cavitation site-to-resonator wall-to-cavitation site bounce of the shock wave. The acoustic period of the cavitation events is about 39 microseconds for this embodiment.

As described herein, the environment within the cavitation resonator 100 and in the local vicinity of the cavitation and sonoluminescence events will in part determine the observable light emitted therefrom. It is understood that the light emitted by SBSL and MBSL must travel through a fluid medium on its way to detection by the human eye or by the PMT apparatus. Therefore, the optical properties of this fluid transmission medium are an important factor in the appearance of the emitted light and the detectability of the same. If the fluid medium is such that it absorbs certain wavelengths of the light spectrum, then those portions of the spectrum will be dimmed or inhibited or blocked and cannot be easily observed from outside the resonator chamber.

At the same time, it is of interest in the present systems what effect the cavitation field and ensuing shock waves around the cavitation region have on the fluid being cavitated. The following discussion is directed to how the acoustical and pressure environment in the fluid influence the optical properties of the fluid. This information can be useful in studying and analyzing the present systems and in understanding the nature of the fluids placed therein.

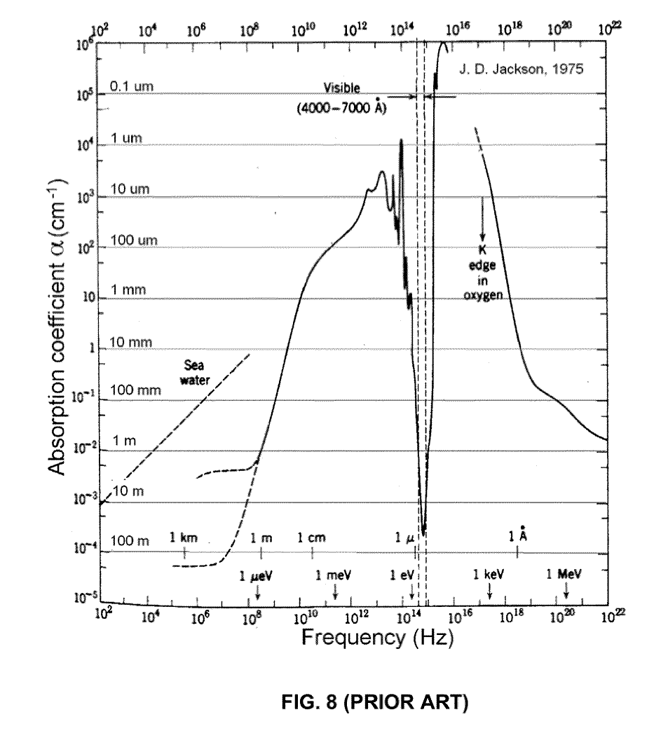

FIG. 8 illustrates the absorption coefficient of water as a function of frequency (J. D. Jackson, Electrodynamics, Wiley, 2^{nd} Ed., 1975). Here it can be seen that water absorbs wavelengths at varying levels across the electromagnetic spectrum, including in the visible range (4000-7000 Angstroms). The figure underlines the wide variation in absorption of light that is achievable across the spectrum.

As to the temperature of the sonoluminescence event, it can be calculated from the spectrum of the emitted light with attention to certain factors that influence the way the light is emitted and received by an actual laboratory apparatus and attention to the effect of the transmission medium (e.g., fluid medium) on the light.

For a black body of absolute temperature T, we may assume that the radiation is emitted as from a spherical source over an area A. The relationship between the wavelength of light emitted by such a black body is known to be given by Equation 1 below:

$${P}_{λ}^{′} ( λ ; T , A ) = A \frac{2 π hc {λ}^{- 5}}{{e}^{hc / λ kT} - 1} \qquad ( Equation 1 )$$

The above relationship assumes an emissivity of 1, and that the emission is isotropic, which may be only an approximation for SBSL and for MBSL emissions.

In some embodiments the present disclosure provides a method for making high amplitude shock waves in water using acoustic cavitation, and includes the steps of increasing the internal static pressure (Ps) of a resonator and introducing sufficient acoustic energy into the resonator to create spontaneous cavitation of the water. The acoustic drive is sinusoidal at the frequency of a resonant mode which has a pressure antinode in the bulk of the water. Implosion of the bubbles created by cavitation creates spherical shock waves within the water thereby pressurizing it and causing the shocked water to glow and exhibit a temperature of between 4,000K and 10,000K.

The water in the vicinity of the shock wave may undergo phase transitions such that its optical and electrical properties are dependent on the local conditions. For example, it has been found that water can become opaque to certain wavelengths and even reflective at certain wavelengths under certain pressure and temperature conditions. The penetration depth (delta) for wavelengths at these frequencies is related to the conductivity (sigma), the speed of sound (c) at a given wavelength (lambda), and is given by Equation 2 below:

δ=\sqrt{λ/πμ₀cσ} (Equation 2)

Water opacity is not measured or observed directly in some aspects hereof. It is rather determined from the measured temperature, derived pressure, Scandia's quantum calculations of the state diagram, and assumptions about light transmission from electrical conductivity.

In some specific embodiments the static pressure within the resonator is greater than 1,000 psia. In other embodiments the static pressure is greater than 2,000 psia. In a specific embodiment, the static pressure within the cavitation resonator is in a range between 2,000 psi and 4,500 psia.

In some embodiments, a fluid handling loop capable of pressure control using a power or manual pump is provided. The fluid handling loop may also include the temperature control monitoring and thermostatic features needed to keep the fluid medium within a certain range of temperatures. In addition, the fluid handling loop is capable of de-gassing and filtration of the fluid medium.

Controls can include computer or manual controls so as to keep the resonator chamber at a desired resonance condition. For example to compensate for fluid and driver fluctuations and other ambient conditions. In some embodiments, this can keep the resonator operating at a zeroth order resonance mode of a spherical resonance chamber with a cavitation and sonoluminescence region near the center of the sphere.

Apertures for flowing fluid into and out of the resonator are used to fill and drain and otherwise control the fluid. The fluid handling loop can be coupled to at least one or two or more such apertures. The apertures may include small passageways to minimize disruption to the acoustic properties of the resonator.

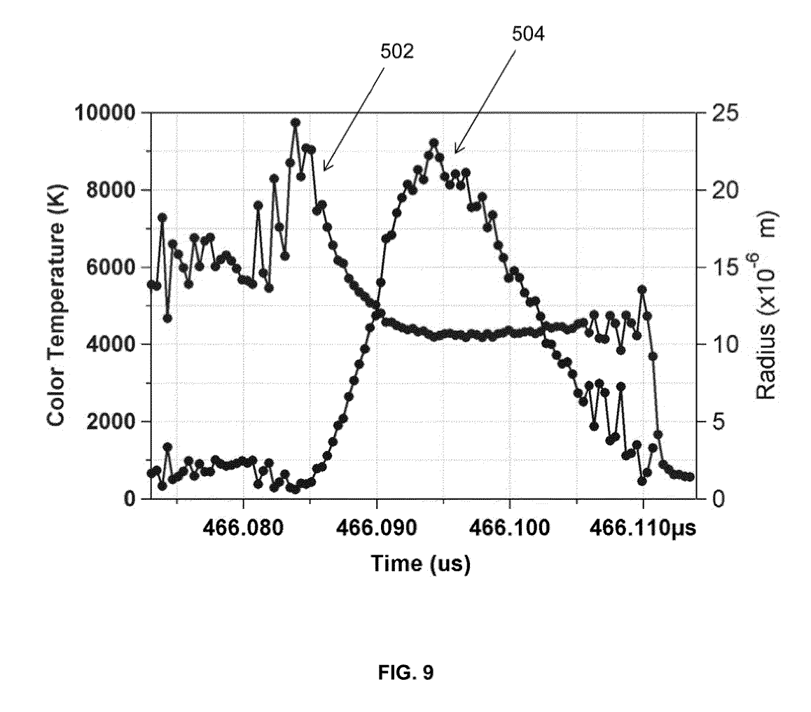

FIG. 9 illustrates an exemplary color temperature plot for a SBSL bubble, along with the radius of the same. The curve/data 502 represents the color temperature (K), and the curve/data 504 represents the radius (um). The shown exemplary color temperature is on the order of 6000K that is created by the SBSL from the sonoluminescence collapse of a single bubble. Bubble expansion and collapse is shown on the right axis of FIG. 9 as a function of time on the horizontal axis. Typically, during bubble collapse, a corresponding increase in color temperature occurs, represented on the left vertical axis of FIG. 9. However, in this case, a color temperature plateau occurs instead marked at approximately 466.090 microseconds (us) and up until 466.110 us where it precipitously drops. High temperatures are correlated with lower wavelength light (around and just above the UV) representing the corresponding temperature. It can be seen that at time 466.090 us that an increase in all wavelengths which represent the bubble maximum. This is because of a phase change in the optical/electrical properties of the fluid (water), and specifically an opaque condition in the water at high degrees of temperature and pressure resulting from the cavitation.

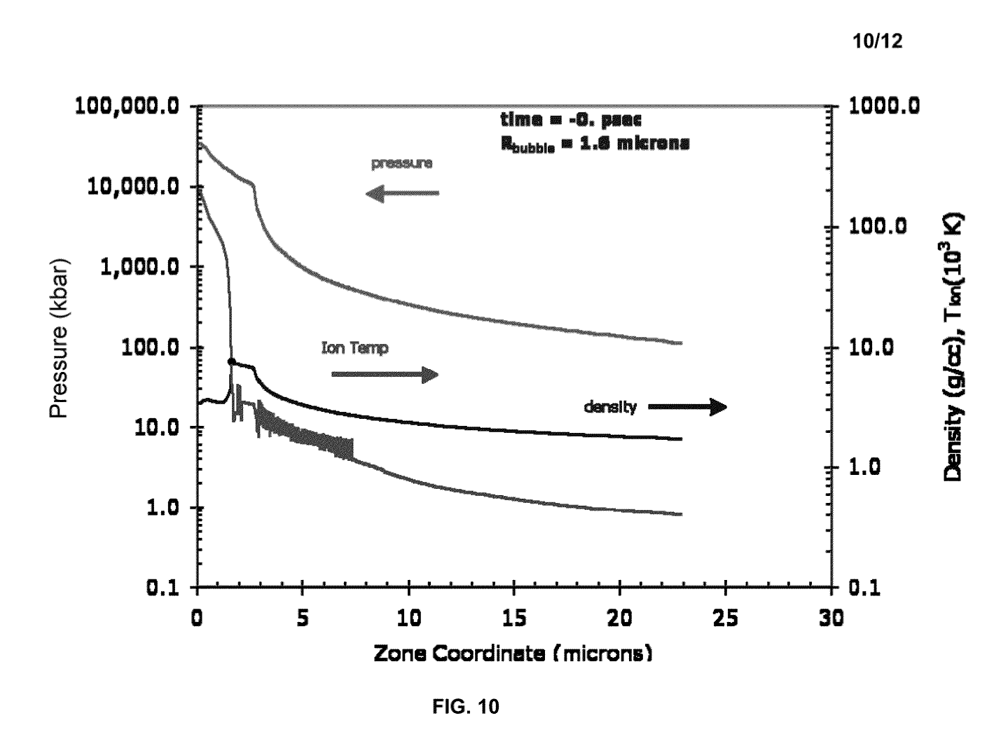

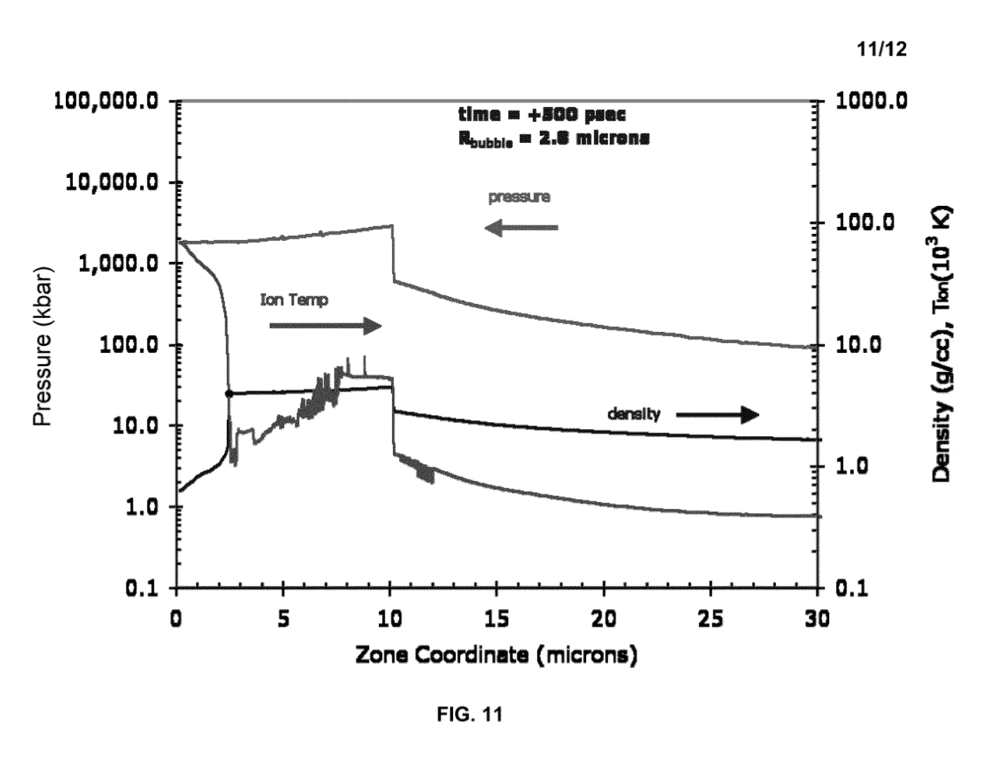

Corroborating this condition are theoretical models depicted in FIGS. 10 and 11. Zone coordinates in microns correspond to bubble wall distance from the center. In FIG. 10, at t=0, everything from the left of 1.6 microns is gas and to the right is liquid. Based on theoretical calculations, a pressure above 4 kbar is necessary to achieve opacity under certain conditions. This can be seen in FIG. 11. FIG. 11 shows the shock wave at t=+500 picoseconds (ps) at a distance of 10 microns where the ion temperature dramatically drops off. This drop off represents the opaque condition at the shock wave front.

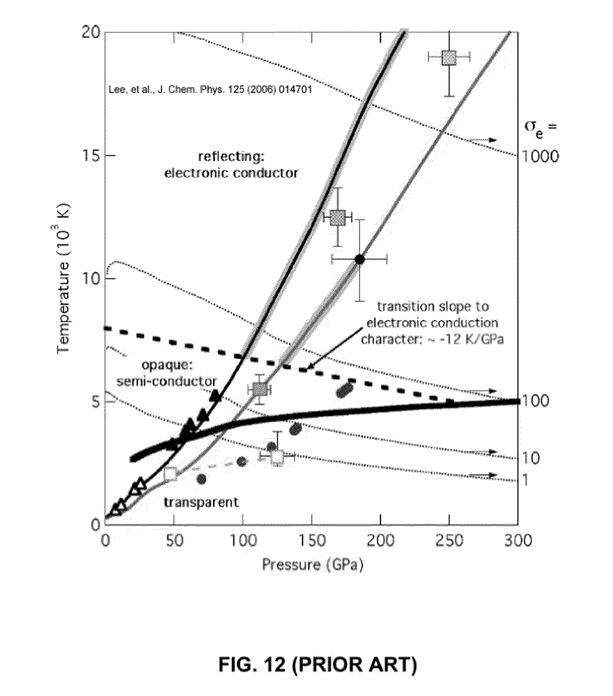

The above discussion is consistent with work (e.g., Lee et al., J. Chem. Phys., 125, (2006) 014701), exemplified in FIG. 12, which shows regimes or phases and transition points where the electrical and optical properties of water change based on the local pressure (in Gpa). The opacity of the water in the resonators of the present invention are therefore correlated with the local conditions induced by the applied acoustic field and the resulting shock waves in the fluid, especially around the cavitation region. Therefore, the optical, electrical, and transmission properties of the fluid in the resonator can be studied, tested, and analyzed by the present apparatus.

The present disclosure is not meant to be limited to the preferred embodiments given herein, but rather is defined by the scope of the claims which follow and by the understanding that one of skill in the art would obtain from the claims, discussion and drawings.

We claim:

1. A system for achieving cavitation within a liquid medium comprising:
a resonator having a shell body substantially enclosing the liquid medium and defining an inner volume within which the liquid medium is confined;
a driving element coupled to said resonator for imparting energy to the resonator for causing cavitation in at least one region of the fluid medium within said resonator;
a fluid pressure control apparatus to control a static pressure of the fluid medium within said resonator; and
an aperture within said shell body through which electromagnetic radiation may pass.

2. The system of claim 1, further comprising a light sensing apparatus optically coupled to said aperture for sensing a quantity of light emanating from said aperture.

3. The system of claim 1, said driving element comprising an acoustical driving source for imparting an acoustical energy to said resonator.

4. The system of claim 3, said acoustical driving source comprising an electrically-powered piezo-acoustic transducer for imparting acoustical energy at a primary oscillation frequency.

5. The system of claim 1, said fluid pressure control apparatus that places the fluid medium under a positive static pressure.

6. The system of claim 5, said pressure control apparatus adapted for raising said static pressure within said resonator to at least 2,000 psi.

7. The system of claim 1, further comprising a fluid temperature control apparatus for controlling a temperature of said fluid medium.

8. The system of claim 1, further comprising a fluid handling loop including said pressure control apparatus and being coupled to said fluid medium within said inner volume by at least one opening through which fluid may pass.

9. The system of claim 8, further comprising a gas content control apparatus for controlling a dissolved gas content within said fluid medium.

10. The system of claim 1, said aperture including a corresponding optically-transmissive window through which light radiation may pass from inside said resonator to the outside of said resonator.

11. The system of claim 1, said resonator comprising a substantially spherical body.

12. A method for determining an optical characteristic of a fluid medium comprising:
placing said fluid medium in a substantially enclosed resonator volume;
raising a static pressure of said fluid medium within said resonator to a given static pressure range;
applying an acoustical driving energy to said resonator so as to cause a sonoluminescence event in at least one region of said fluid medium within said resonator and so as to emit light from said region as a result of said sonoluminescence event; and
determining a phase of said fluid medium where said phase deminishes a transmission characteristic of at least a range of wavelengths of said light emitted from said sonoluminescence event.

13. The method of claim 12, raising said static pressure comprising raising the pressure within said resonator to at least 2,000 psia.

14. The method of claim 12, applying an acoustical driving energy further comprising causing a response from said resonator to said driving energy so as to achieve a quality factor (Q) of at least 3,000 from said resonator.

15. The method of claim 12, applying said acoustic driving energy comprising applying an electrical power signal to drive a transducer that converts said electrical power signal to a corresponding mechanical energy.

16. The method of claim 15, said electrical power signal comprising frequency components matched to an acoustical resonance mode of said resonator.

17. The method of claim 12, further comprising manufacturing said resonator by fixing two substantially hemispherical shell portions to one another to form a substantially spherical resonator shell body therefrom.

18. The method of claim 12, applying an acoustical driving energy to said resonator so as to cause a sonoluminescence event in at least one region of said fluid medium comprising applying an acoustical driving energy to said resonator so as to cause a sonoluminescence event in at least one region of a liquid water medium.

19. The method of claim 12, applying an acoustical driving energy to said resonator so as to cause a sonoluminescence event in at least one region of said fluid medium comprising applying an acoustical driving energy to said resonator so as to cause a sonoluminescence event in at least one region of a liquid metal medium.

20. The method of claim 19, applying an acoustical driving energy to said resonator so as to cause a sonoluminescence event in at least one region of said fluid medium comprising applying an acoustical driving energy to said resonator so as to cause a sonoluminescence event in at least one region of a liquid gallium medium.

21. The method of claim 12, applying an acoustical driving energy to said resonator so as to cause a sonoluminescence event in at least one region of said fluid medium comprising applying an acoustical driving energy to said resonator so as to cause a sonoluminescence event in at least one region of a liquid sodium medium.

22. The method of claim 12, further comprising measuring a temperature of a cavitation event.

23. The method of claim 12, further comprising determining a tuning condition of said resonator so as to maintain the driving energy at a resonance of said resonator.
